(19) United States
(12) Patent Application Publication
(10) Pub. No.: US 2014/0346964 A1
(43) Pub. Date: Nov. 27, 2014

(54) APPLICATION CIRCUIT AND CONTROL METHOD THEREOF

(71) Applicant: Lextar Electronics Corporation, Hsinchu (TW)

(72) Inventors: Chun-Kuang CHEN, Taipei City (TW); Po-Shen CHEN, Hsinchu City (TW)

(73) Assignee: Lextar Electronics Corporation, Hsinchu (TW)

(21) Appl. No.: 14/173,823

(22) Filed: Feb. 6, 2014

(30) Foreign Application Priority Data
May 24, 2013 (TW) 102118531

(51) Int. Cl. H05B 33/08

(52) U.S. Cl. CPC H05B 33/0842
USPC 315/200 R; 315/307

(57) ABSTRACT

An application circuit includes a dynamic load circuit and a control circuit. The dynamic load circuit is electrically connected to a light source. The control circuit is electrically connected to the dynamic load circuit and a TRIAC. The control circuit controls the load status of the dynamic load circuit based on output current from the TRIAC, so as to turn on the light source.

### RELATED APPLICATIONS

This application claims priority to Taiwan Patent Application No. 102118531, filed May 24, 2013, the entirety of which is herein incorporated by reference.

### BACKGROUND

1. Technical Field

The present disclosure relates to a circuit; more particularly, an application circuit and a control method thereof.

2. Description of Related Art

Conventional dimmers adopt the structure of triode for alternating current (TRIAC); since incandescent light sources are resistor-type loads, they are primarily used in adjusting the brightness of the incandescent light sources. When adjusting the angle of the external knob of the dimmer, the resistance value of the variable resistor within the dimmer will also change accordingly, thereby accomplishing the control of the brightness/darkness of the outputted light.

For example, the incandescent light sources may be halogen light bulbs which is a resistor-type load and connected with a commercially-available TRIAC; when the knob is turned from the lowest position to the highest position, the angle at which the input power is sufficient to turn on the TRIAC while at the same time turn on the halogen light bulb, said angle is called the minimum starting angle.

Halogen light bulbs are loads that require high wattage, and consume more power during usage. When the light bulb is turned on at the minimum starting angle, the power consumption is 12 W. Due to such high power consumption, the current that mains supply inputs into the light bulb is high; hence, the TRIAC may turn on the light bulb at a lower turn-on angle of about 76 degrees, and the input voltage waveform from the TRIAC control would not loss the fidelity.

However, in recent years, the industrial trend is to use light-emitting diodes (LEDs) to replace incandescent light bulbs to save the energy consumption; however, the TRIAC is still required for the control of the brightness of the light source. Nonetheless, LEDs are not transistor-type loads, and the power consumption thereof is about 9.3 W, which is much lesser than the conventional light sources, and hence, the input current is insufficient to provide the holding current required for turning on the TRIAC itself. Therefore, when the TRIAC is used to control the turn on of the light source, the TRIAC shall be turned to a larger turn-on angle (e.g., about 107 degrees) in order to turn on the LED light bulb. The turn-on angle for the LED light bulb is 107 degrees, which is way larger than the turn-on angle of 76 degrees for the conventional light bulb, as could be appreciated, if the LED light bulb cannot provide functionalities similar to that of the conventional light bulb, the consumer would not choose the LED light bulb as an alternative to the conventional light bulb.

Experimental results suggest that one may suffer from one of the following conditions when using the TRIAC to control the LED light sources:

1. Due to the low power consumption of the LED light source, the TRIAC control can only turn on the LED light source at a higher turn-on angle;

2. At the lower turn-on angle, the fidelity of the TRIAC wave form will decrease, thereby resulting in the flickering of the LED light source, which may make the users feel uncomfortable;

3. The discrepancies in the quality of commercial TRIACs from various brands tend to cause the problems associated with matching of the unit under test.

In view of the foregoing, there exist problems and disadvantages in the existing products that await further improvement. However, those skilled in the art sought vainly for a solution. In order to solve or circumvent above problems and disadvantages, there is an urgent need in the related field to address the above-mentioned problems and disadvantages.

### SUMMARY

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

In one aspect, the present disclosure provides an application circuit and a control method thereof to overcome the problems which has faced the prior art.

The present disclosure provides an application circuit comprising a dynamic load circuit and a control circuit. The dynamic load circuit is electrically connected to the light source, and the control circuit is electrically connected to the dynamic load circuit and a triode for alternating current (TRIAC). The control circuit is configured to control the load status of the dynamic load circuit based on the output current from the TRIAC, so as to turn on the light source. In one embodiment, the dynamic load circuit comprises a switching element and a dynamic load. The switching element and dynamic load are in series connection with each other, wherein the switching element is connected to one terminal of the light source, whereas the dynamic load is connected to the other terminal of the light source. The on/off state of the switching element is under the control of the control circuit.

In one embodiment, the control circuit comprises a detecting unit and a comparator. The detecting unit is configured to detect the output current from the TRIAC, and convert the output current into a voltage signal; and the comparator is configured to compare the voltage signal with a minimum default conduction signal, and turn on or turn off the switching element based on the comparison result.

In one embodiment, the detecting unit comprises a current sensor, an absolute-value circuit and an integrating circuit. The absolute-value circuit is electrically connected to the current sensor, and the integrating circuit is electrically connected to the absolute-value circuit and the comparator. The current sensor is configured to sense the output current from the TRIAC, wherein the output current is an alternating current wave form signal; the absolute-value circuit is configured to convert the alternating current wave form signal into a positive wave form signal; the integrating circuit configured to convert the positive wave form signal into a direct current voltage for use as the voltage signal.

In one embodiment, when the voltage signal is less than the minimum default conduction signal, the comparator outputs a trigger signal to turn on the switching element, such that the dynamic load and the light source are in parallel connection.

In another embodiment, when the voltage signal is greater than the minimum default conduction signal, the comparator outputs a closed signal to cut off the switching element.

In one embodiment, the light source comprises at least one light-emitting diode and a light-emitting diode driver. The light-emitting diode driver is configured to drive the light-emitting diode.

On the other hand, the application circuit provided by the present disclosure comprises a dynamic load circuit electrically connected to the light source, and the control method of the application circuit comprises the step(s) of: controlling the load status of the dynamic load circuit based on the output current from the TRIAC, so as to turn on the light source.

In one embodiment, the dynamic load circuit comprises a switching element and a dynamic load, the switching element being connected to one terminal of the light source, the dynamic load being connected to the other terminal of the light source, the switching element and the dynamic load are in series connection with each other, wherein the step of controlling the load status of the dynamic load circuit based on the output current from the TRIAC comprises: detecting the output current from the TRIAC. and converting the output current into a voltage signal; comparing the voltage signal with a minimum default conduction signal, and turning on or turning of the switching element based on the comparison result.

In one embodiment, the step of detecting the output current from the TRIAC and converting the output current into the voltage signal comprises: sensing the output current from the TRIAC, wherein the output current is an alternating current wave form signal; converting the alternating current wave form signal into a positive wave form signal; and converting the positive wave form signal into a direct current voltage for use as the voltage signal.

In one embodiment, the step of turning on the switching element comprises: when the voltage signal being less than minimum default conduction signal, outputting a trigger signal to turn on the switching element, such that the dynamic load and the light source are in parallel connection.

In another embodiment, the step of turning off the switching element comprises: when the voltage signal being greater than minimum default conduction signal, outputting a closed signal to cut off the switching element.

In one embodiment, the light source comprises at least one light-emitting diode and a light-emitting diode driver, in which the light-emitting diode driver is configured to drive the light-emitting diode.

In view of the foregoing, the technical solutions of the present disclosure result in significant advantageous and beneficial effects, compared with existing techniques. The implementation of the above-mentioned technical solutions achieves substantial technical improvements and provides utility that is widely applicable in the industry. Specifically, technical advantages generally attained, by embodiments of the present invention, include:

1. The application circuit supports TRAIC for use in light-emitting diode drivers with low power consumption, such that the turn-on angle of the LED light bulb is comparable to that of the conventional bulb;

2. It is feasible to increase the control of holding current at low turn-on angle, that is, it can turn on the LED light source at the low turn-on angle;

3. When the inputted holding current is sufficient to maintain the ON status of the TRAIC, the application circuit may exclude the dynamic load, thereby reducing the energy consumption at the higher turn-on angle; and

4. Given the discrepancies in the quality of TRAICs from various brands, the application circuit may increase the adaptability of unit under test.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawing, wherein:

FIG. 1 is a block diagram illustrating an application circuit according to one embodiment of the present disclosure; and

FIG. 2 is a flow diagram illustrating a control method of the application circuit according to one embodiment of the present disclosure.

### DETAILED DESCRIPTION

In the following detailed description, for purposes of explanation, numerous specific details are set forth in order to attain a thorough understanding of the disclosed embodiments. In accordance with common practice, the various described features/elements are not drawn to scale but instead are drawn to best illustrate specific features/elements relevant to the present invention. Also, like reference numerals and designations in the various drawings are used to indicate like elements/parts. Moreover, well-known structures and devices are schematically shown in order to simplify the drawing and to avoid unnecessary limitation to the claimed invention.

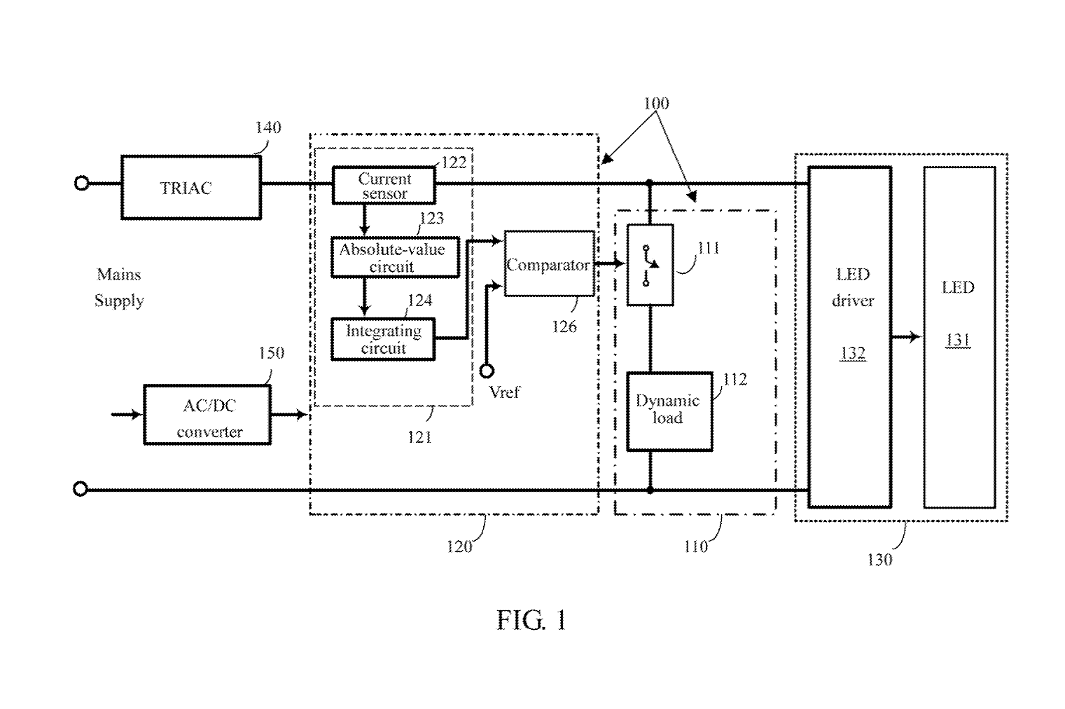

FIG. 1 is a block diagram illustrating an application circuit 100 according to embodiments of the present disclosure. As illustrated in FIG. 1, the application circuit 100 comprises a dynamic load circuit 110 and a control circuit 120. In structure, the dynamic load circuit 110 is electrically connected to the light source 130, the control circuit 120 is electrically connected to the dynamic load circuit 110 and the TRAIC 140, and an AC/DC converter 150 is electrically connected to the control circuit 120.

In FIG. 1, the light source 130 comprises at least one light-emitting diode (LED) 131 and a light-emitting diode driver (LED driver) 132. In operation, the light-emitting diode driver 132 is configured to drive the LED 131. It should be noted that the application circuit of the present disclosure is suitable for use in light-emitting diode drivers of various types and not limited to the circuits from different brands or manufactures.

The brightness of the LED 131 is adjustable, and the application of the LED 131 in the light source system has become the mainstream trend of the industry; however, it shall be used together with the TRAIC 140, and hence, the application circuit 100 of the present disclosure provides a good adjustment mechanism for achieving a better brightness control effect.

Specifically, in operation, the AC/DC converter 150 converts the mains supply into DC source for the control circuit 120, the TRAIC 140 receives the mains supply and inputs the current to the control circuit 120, the control circuit 120 is configured to control the load status of the dynamic load circuit 120 based on the output current from the TRAIC 140. The present disclosure maintains the output current by the addition of a dynamic load control so as to turn on the light source 130 and enhance the lighting quality.

In FIG. 1, the dynamic load circuit 110 comprises a switching element 111 and a dynamic load 112. In structure, the switching element 111 and the dynamic load 112 are in series connection with each other, wherein the switching element 111 is connected to one terminal of the light source 130, and the dynamic load 112 is connected to the other terminal of the light source 130. In implementation, the dynamic load 112 may be a resistor or an impedance component consisting of metal oxide semiconductor(s). In operation, the on/off state of the switching element 111 is under the control of the control, circuit 120.

The control circuit 120 comprises a detecting unit 121 and a comparator 126, In Structure, the TRAIC 140 is electrically connected to the detecting unit 121, and the detecting unit 121 is electrically connected to the comparator 126. In operation, the detecting unit 121 is configured to detect the output current from the TRAIC 140, and convert the output current into a voltage signal; and the comparator 126 is configured to compare the voltage signal with a minimum default conduction signal (Vref),and turn on or turn off the switching element 111 based on the comparison result. In implementation, the user may set the minimum conduction signal (Vref) based on the turn-on angle of a required minimum-starting angle.

In the case where the voltage signal is less than the minimum default conduction signal, which means that it is a small turn-on angle or the TRAIC 140 is cut off, the comparator 126 outputs an trigger signal to turn on the switching element 111, such that the dynamic load 112 and the light source 130 are in parallel connection, thereby allowing the light source 130 to be lit under a small turn-on angle, so as to match the operating mode of conventional light bulbs. In one experiment, the turn-on angle has been improved from the original 107 degrees to 78.4 degrees, which is quite close to the starting angle of 76 degrees required for conventional halogen bulbs.

On the other hand, when the voltage signal is greater than the minimum default conduction signal, which means that the output current is sufficient to maintain the TRAIC 140 in the ON status and the power required by the LED light source 130, the comparator 126 outputs an closed signal 111 to cut off the switching element 111, thereby excluding said dynamic load 112 and reduces the energy consumption.

In one embodiment, the detecting unit 121 comprises a current sensor 122, an absolute-value circuit 123 and an integrating circuit 124. In structure, the TRAIC 140 is electrically connected to the current sensor 122, the current sensor 122 is electrically connected to the absolute-value circuit 123, and the absolute-value circuit 123 is electrically connected to integrating circuit 124. In operation, the current sensor 122 is configured to sense the output current of the TRAIC 140, wherein the output current is an alternating current wave form signal; the absolute-value circuit 123 is configured to convert the alternating current wave form signal into a positive wave form signal; and the integrating circuit 124 is configured to convert the positive wave form signal into a direct current voltage for use as the voltage signal.

Alternatively, in another embodiment, the detecting unit 121 may be formed by other circuits, and persons having ordinary skill in the art may flexibly choose it depending on actual need(s).

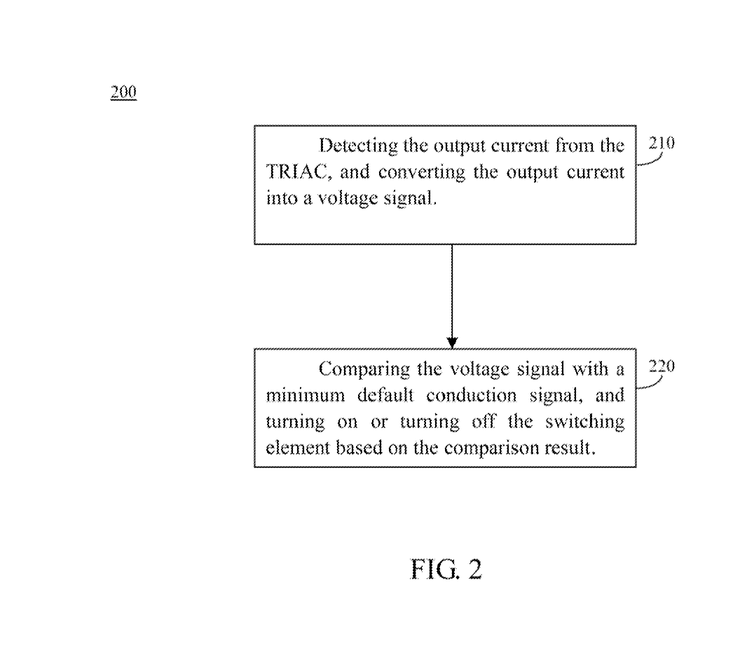

FIG. 2 is a flow chart illustrating a control method 200 of the application circuit 100 according to one embodiment of the present disclosure. As illustrated in FIG. 2, the control method 200 comprises steps 210-220. It should be appreciated that the steps are not recited in the sequence in which the steps are performed. That is, unless the sequence of the steps is expressly indicated, the sequence of the steps is interchangeable, and all or part of the steps may be simultaneously, partially simultaneously, or sequentially performed. Also, the hardware devices for implementing these steps have been specifically disclosed in the above embodiments, and hence, detailed description thereof is omitted herein for the sake of brevity.

The control method 200 could be the function performed by the control circuit 120 of FIG. 1, which is primarily based on the output current of the TRAIC 140 to control the load status of the dynamic load circuit 120, so as to turn on the light source 130. The present disclosure, by the addition of a dynamic load control mode to maintain the output current, allows the user to turn on the light source 130 and improve the lighting quality.

Specifically, as illustrated in FIG. 2, in the step 210, the output current from the TRIAC is detected, and the output current is converted into a voltage signal; next, in the step 220, the voltage signal is compared with a minimum default conduction signal, and the switching element is turned on or turned off based on the comparison result. In implementation, the user may set the minimum trigger signal based on the turn-on angle required for setting the minimum starting angle.

In one embodiment, the step 210 may comprise: sensing the output current from the TRIAC, wherein the output current is an alternating current wave form signal; converting the alternating current wave form signal into a positive wave form signal; and converting the positive wave form signal into a direct current voltage for use as the voltage signal,

In one embodiment, the step 220 may comprises: when the voltage signal is less than a minimum default conduction signal, outputting a trigger signal to turn on the switching element, such that the dynamic load and the light source are in parallel connection, thereby allowing the light source 130 to be lit under a small turn-on angle, so as to match the operating mode of conventional light bulbs.

In another embodiment, the step 220 may comprise: when the voltage signal is greater than the minimum default conduction signal, outputting a closed signal to cut off the switching element, thereby excluding said dynamic load and reduces the energy consumption.

In view of the foregoing, the present invention focuses on improving the function of the light source circuit (e.g., an LED drive circuit) originally supporting the triode for alternating current. The present disclosure has the following advantageous characteristics: 1. Increasing a dynamic load circuit to allow the turning on of the light source (e.g., LED) under a small turn-on angle, so that the operation mode thereof matches the conventional bulbs; 2. When the switch is not turned on or under a small turn-on angle, increasing a dynamic load control mode to maintain the input circuit, thereby improving the lighting quality; 3. The triode for alternating current, when under a high turn-on angle, uses the switching element to exclude such dynamic load, so as to reduce the energy consumption; 4. Since it is disposed on the input terminal of the mains supply, it is suitable to support various light-emitting diode drivers, and is not limited to circuits from any brands and/or manufacturers.

Although various embodiments of the invention have been described above with a certain degree of particularity, or with reference to one or more individual embodiments, they are not limiting to the scope of the present disclosure. Those with ordinary skill in the art could make numerous alterations to the disclosed embodiments without departing from the spirit or scope of this invention. Accordingly, the protection scope of the present disclosure shall be defined by the accompany claims.

What is claimed is:

1. An application circuit, comprising:
a dynamic load circuit, electrically connected to a light source; and
a control circuit, electrically connected to the dynamic load circuit and a triode for alternating current (TRIAC), configured to control a load status of the dynamic load circuit based on an output current from the TRIAC, so as to turn on the light source.

2. The application circuit according to the claim 1, wherein the dynamic load circuit comprises:
a switching element, connected to one terminal of the light source, wherein an on/off state of the switching element is under the control of the control circuit; and
a dynamic load, connected to the other terminal of the light source, wherein the switching element and the dynamic load are in series connection with each other.

3. The application circuit according to the claim 1, wherein the control circuit it comprises:
a detecting unit, configured to detect the output current from the TRIAC, and convert the output current into a voltage signal; and
a comparator, configured to compare the voltage signal with a minimum default conduction signal, and to turn on or turn off the switching element based on the comparison result.

4. The application circuit according to the claim 3, wherein the detecting unit comprises:
a current sensor, configured to sense the output current from the TRIAC, wherein the output current is an alternating current (AC) wave form signal;
an absolute-value circuit, electrically connected to the current sensor, configured to convert the AC wave form signal into a positive wave form signal; and
an integrating circuit, electrically connected to the absolute-value circuit and the comparator, configured to convert the positive wave form signal into a direct current voltage for use as the voltage signal.

5. The application circuit according to the claim 3, wherein when the voltage signal is less than the minimum default conduction signal, the comparator outputs a trigger signal to turn on the switching element, such that the dynamic load and the light source are in parallel connection.

6. The application circuit according to the claim 3, wherein when the voltage signal is greater than the minimum default conduction signal, the comparator outputs a closed signal to cut off the switching element.

7. The application circuit according to the claim 1, wherein the light source comprising:
at least one light-emitting diode; and
a light-emitting diode driver, configured to drive the light-emitting diode.

8. A control method of an application circuit, the application circuit comprising a dynamic load circuit electrically connected to a light source, the control method comprising:
controlling a load status of the dynamic load circuit based on an output current from a TRIAC, so as to turn on the light source.

9. The control method according to the claim 8, the dynamic load circuit comprising a switching element and a dynamic load, the switching element being connected to one terminal of the light source, the dynamic load being connected to the other terminal of the light source, the switching element and the dynamic load being in series connection with each other, wherein the step of controlling the load status of the dynamic load circuit based on the output current from a TRIAC comprises:
detecting the output current from the TRIAC, and converting the output current into a voltage signal; and
comparing the voltage signal with a minimum default conduction signal, and turning on or turning off the switching element based on the comparison result.

10. The control method according to the claim 9, wherein the step of detecting the output current from the TRIAC and converting the output current into the voltage signal comprises:
sensing the output current from the TRIAC, wherein the output current is an alternating current wave form signal;
converting the alternating current wave form signal into a positive wave form signal; and
converting the positive wave form signal into a direct current voltage for use as the voltage signal.

11. The control method according to the claim 9, wherein the step of turning on the switching element comprises:
outputting a trigger signal to turn on the switching element when the voltage signal is less than the minimum default conduction signal, such that the dynamic load and the light source are in parallel connection .

12. The control method according to the claim 9, wherein the step of turning off the switching element comprises:
outputting a closed signal to cut off the switching element when the voltage signal is greater than the minimum default conduction signal.

13. The control method according to the claim 8, wherein the light source comprises at least one light-emitting diode and a light-emitting diode driver for driving the light-emitting diode.
